(19) United States
(12) Patent Application Publication
(10) Pub. No.: US 2005/0245724 A1
(43) Pub. Date: Nov. 3, 2005

(54) Process for production of polymer polyol, and polymer polyol

(75) Inventors: Hidemasa Horiguchi, Kyoto-shi (JP); Hiroki Mori, Kyoto-shi (JP); Hidefumi Ohta, Kyoto-shi (JP)

Correspondence Address: Hamre, Schumann, Mueller & Larson, P.C., P.O. Box 2902-0902, Minneapolis, MN, 55402, US

(73) Assignee: SANYO CHEMICAL INDUSTRIES, LTD., Kyoto-shi (JP)

(21) Appl. No.: 10/503,840

(22) PCT Filed: Apr. 8, 2003
(86) PCT No.: PCT/JP03/04424

§ 371 Date: Aug. 6, 2004

(30) Foreign Application Priority Data
Apr. 10, 2002 (JP) 2002-108382

(51) Int. Cl. C08J 9/00

(52) U.S. Cl. 528/425

(57) ABSTRACT

A polymer polyol comprising 25 to 60 mass % polyol (A) and 40 to 75 mass % of polymer particles (B1) formed by polymerizing ethylenically unsaturated monomer in the polyol (A), the ethylenically unsaturated monomer having the content of acrylonitrile and/or styrene is not less than 50 mass %, wherein (B1) has a particle size of not more than 100 μm and contains not less than 95 mass % of particles with the particle size of 0.01 to 10 μm; and the total content of acrylonitrile and styrene is not more than 20 ppm; and process for producing the polymer polyol. The polymer polyol exhibits a reduced residual monomer content and excellent filtration property and is useful as a raw material in the production of polyurethane or the like.

### TECHNICAL FIELD

The present invention relates to a process for producing polymer polyol and a polymer polyol.

### BACKGROUND ART

Hitherto, as a method for reducing the residual monomers in polymer polyol, a method for stripping under high vacuum/high temperature conditions for a long time has been well known.

However, lengthy stripping lowers the productivity. In particular, in recent years, in order to improve the physical properties of polyurethane molded product using polymer polyol and to facilitate the molding system, polymer polyol having a high content of polymers has been required. There is a problem in that the increased content of polymers leads to the dogging of a strainer, thus lowering the productivity.

The inventors of the present invention have made earnest investigations to solve these problems, and reached the present invention.

### SUMMARY OF THE INVENTION

The present inventions are as follows:

[First Invention] A process for producing polymer polyol in which a residual monomer is reduced, the process comprising: removing an organic solvent (II) from a liquid composition including a base polymer polyol (I) obtained by polymerizing ethylenically unsaturated monomer (b) in polyol (A) and an organic solvent (II) that is present in a content of not less than 3 mass % with respect to the mass of (I), wherein the organic solvent (II) comprises an organic solvent (II-1) having a SP value of 7 to 14 (cal/cm³)^{1/2} and a boiling point that satisfies the following relational formula (1):
850/s≦bp≦1100/s (1)
where
s represents an SP value of the organic solvent, and
bp represents a boiling point of the organic solvent.

[Second Invention] A process for producing polymer polyol in which a residual monomer is reduced, the process comprising: mixing a base polymer polyol (I) obtained by polymerizing ethylenically unsaturated monomer (b) in polyol (A) and an organic solvent (II) that is present in a content of not less than 3 mass % with respect to the mass of (I); and removing the organic solvent (II) from a liquid composition, wherein the organic solvent (II) comprises an organic solvent (IIa) having a SP value of 7 to 14 (cal/cm³)^{1/2} and a boiling point of 60° C. to 150° C.

[Third Invention] Polymer polyol comprising 25 to 60 mass % polyol (A) and 40 to 75 mass % of polymer particles (B1) formed by polymerizing ethylenically unsaturated monomer in the polyol (A), the ethylenically unsaturated monomer having a content of acrylonitrile and/or styrene of not less than 50 mass %, wherein (B1) has a particle size of not more than 100 μm and contains not less than 95 mass % of particles with the particle size of 0.01 to 10 μm; and the total residual content of acrylonitrile and styrene that is not more than 20 ppm.

### DISCLOSURE OF THE INVENTION

As the polyol (A) in the present invention, known polyols usually used in the production of polymer polyols may be employed. For example, compounds (A1) having a structure formed by adding an alkylene oxide to a compound containing at least two (preferably 2 to 8) active hydrogen atoms (e.g. polyhydric alcohols, polyhydric phenols, amines, polycarboxylic acids and phosphoric acids) and mixtures thereof may be used.

Among these, compounds having a structure formed by adding an alkylene oxide to a polyhydric alcohol are preferred.

The polyhydric alcohols include dihydric alcohols having 2 to 20 carbon atoms (aliphatic diols, for instance, alkylene glycols such as ethylene glycol, propylene glycol, 1,3- and 1,4-butanediol, 1,6-hexanediol, and neopentylglycol; and alicyclic diols, for instance, cycloalkylene glycols such as cyclohexanediol and cyclohexanedimethanol); trihydric alcohols having 3 to 20 carbon atoms (aliphatic triols, for instance, alkane triols such as glycerin, trimethylolpropane, trimethylolethane, and hexanetriol); polyhydric alcohols having 4 to 8 or more hydroxyl groups and 5 to 20 carbon atoms (aliphatic polyols, for instance, alkane polyols and intramolecular or intermolecular dehydration products of the same and alkane triol such as pentaerythritol, sorbitol, mannitol sorbitan, diglycerin, and dipentaerythritol; and saccharides and derivatives of the same, such as sucrose, glucose, mannose, fructose, and methylglucoside).

The polyhydric phenols include monocyclic polyhydric phenols such as pyrogallol, hydroquinone and phloroglucinol; bisphenols such as bisphenol A, bisphenol F and bisphenol sulfone; and condensation products of phenols and formaldehyde (novolak).

The amines include ammonia; and aliphatic amines such as alkanol amines having 2 to 20 carbon atoms (e.g. monoethanolamine, diethanolamine, isopropanolamine and aminoethylethanolamine), alkyl amines having 1 to 20 carbon atoms (e.g. n-butylamine and octylamine), alkylene diamines having 2 to 6 carbon atoms (e.g. ethylenediamine, propylenediamine and hexamethylenediamine), and polyalkylene polyamines (from dialkylene triamines to hexaalkylene heptamines having 2 to 6 carbon atoms in the alkylene group, e.g. diethylenetriamine and triethylenetetramine).

The amines further include aromatic mono- or polyamines having 6 to 20 carbon atoms (e.g. aniline, phenylenediamine, tolylenediamine, xylylenediamine, diethyl toluenediamine, methylenedianiline, and diphenyl ether diamine); alicyclic amines having 4 to 20 carbon atoms (isophoronediamine, cyclohexylenediamine and dicyclohexylmethanediamine); and heterocyclic amines having 4 to 20 carbon atoms (e.g. aminoethylpiperazine), and the like.

The polycarboxylic acids include aliphatic polycarboxylic acids having 4 to 18 carbon atoms (e.g. succinic acid, adipic acid, sebacic acid, glutaric acid, and azelaic acid), aromatic polycarboxylic acids having 8 to 18 carbon atoms (e.g. terephthalic acid and isophthalic acid), and mixtures of two or more thereof.

As the alkylene oxide added to the above active hydrogen-containing compound, alkylene oxides having 2 to 8 carbon atoms are preferable. The alkylene oxides include ethylene oxide (hereinafter abbreviated as EO), propylene oxide (hereinafter abbreviated as PO), 1,2-, 1,3-, 1-4, or 2,3-butylene oxide (hereinafter abbreviated as BO), styrene oxide (hereinafter abbreviated as SO), and the like, and combinations of two or more thereof (block addition and/or random addition). Preferably, PO or a combination of PO and EO (containing not more than 25 mass % of EO) is used.

Specific examples of the polyol are adducts of PO to the above active hydrogen-containing compound, adducts of PO and other alkylene oxide (hereinafter abbreviated as AO), preferably EO, to the above active hydrogen-containing compounds produced by the following methods, or esterification products of these adduct compounds with a polycarboxylic acid or phosphoric acid:
(i) block addition of PO-AO in this order (tipped);
(ii) block addition of PO-AO-PO-AO in this order (balanced);
(iii) block addition of AO-PO-AO in this order;
(iv) block addition of PO-AO-PO in this order (active secondary);
(v) random addition of mixed PO and AO; and
(vi) random addition or block addition according to the order described in the specification of U.S. Pat. No. 4,226,756.

Furthermore, a hydroxyl equivalent of the compound (A1) is preferably 200 to 4000, more preferably 400 to 3000. Two or more types of compounds (A1) in combination having a total hydroxy equivalent in the foregoing range preferably are used as well.

As the polyol (A), the compounds (A1) having a structure formed by adding an alkylene oxide to the active hydrogen-containing compound in combination with other polyols (A2) may be used. In this case, the use ratio (by mass) of (A1)/(A2) is preferably from 100/0 to 80/20.

Other polyols (A2) include high-molecular polyols such as polyester polyols and diene-type polyols, and mixtures thereof.

The polyester polyols include: condensation reaction products of the above described polyhydric alcohols and/or polyether polyols (e.g. dihydric alcohols such as ethylene glycol diethylene glycol propylene glycol 1,3- or 1,4-butanediol, 1,6-hexanediol and neopentylglycol, mixtures of these dihydric alcohols with polyhydric alcohols having three or more hydroxyl groups, such as glycerin and trimethylol propane, and low-mole (1 to 10 moles) alkylene oxide adducts of these polyhydric alcohols) with the above described polycarboxylic acids, or esterforming derivatives such as anhydrides of the polycarboxylic adds or lower alkyl (the number of carbon atoms in the alkyl group: 1 to 4) esters of the polycarboxylic adds (e.g. adipic add, sebacic acid, maleic anhydride, phthalic anhydride, dimethyl terephthalate, etc.), or condensation reaction products of the above-described polyhidric alcohol and/or polyether polyol with the above-described carboxylic anhydride and alkylene oxide; alkylene oxide (EO, PO, etc.) adducts of the condensation reaction products; polylactone polyol, for instance, products obtained by ring-opening polymerization of lactones (ε-caprolactone, etc.) by using the above-described polyhydric alcohol as an initiator; polycarbonate polyols, for instance, a reaction product of the above-described polyhydric alcohol and alkylene carbonate; and the like.

Furthermore, the other polyols (A2) include diene-type polyols such as polybutadiene polyol and hydrogenate products of the same; hydroxyl-containing vinyl polymers such as acrylic polyols; polyols based on a natural oil, such as castor oil; modification products of natural oil-based polyols; and the like.

These polyols (A2) usually have 2 to 8 hydroxyl groups, preferably 3 to 8 hydroxyl groups, and usually have a hydroxyl equivalent of 200 to 4000, preferably 400 to 3000.

The number-average molecular weight (according to gel permeation chromatography (GPC); this also applies to the number-average molecular weights described below until otherwise specified) of the polyol (A) is usually at least 500, preferably from 500 to 20,000, particularly preferably from 1,200 to 15,000, and most preferably from 2,000 to 9,000. When the number-average molecular weight of the polyol (A) is not less than 500, the polyurethane foam produced is preferable from the view point of the foaming property. Furthermore, when the number-average molecular weight of (A) is not more than 20000, the viscosity of (A) is low, and it is desirable from the aspect of the handling properties of the polymer polyol. Furthermore, the polyol (A) preferably has a hydroxyl equivalent of 200 to 4000, and more preferably 400 to 3000.

Examples of ethylenically unsaturated monomer (b) used for producing base polymer polyol include aromatic hydrocarbon monomers (b1), unsaturated nitryls (b2), (meth)acrylic acid esters (b3), a terminal-ethylenically-unsaturated-group containing compound (b4) having a number-average molecular weight of 160 to 490 and a SP value of 9.5 to 13 [(cal/cm³)^{1/2}, the same is true hereinafter], an unsaturated polyester (b5) other than the above-mentioned polyester, having a number-average molecular weight of not less than 500, other ethylenically unsaturated monomer (b6), and mixtures of two or more thereof.

Examples of (b1) include styrene, α-methylstyrene, hydroxystyrene, chlorostyrene, and the like.

Examples of (b2) include acrylonitrile, methacrylonitrile, and the like.

For (b3), compounds composed of C, H and O atoms and having a number average molecular weight of less than 500 are included. Examles of (b3) include (meth)acrylic acid alkyl esters (the number of carbon atoms in the alkyl group: 1 to 24) such as methyl(meth)acrylate, butyl(meth)acrylate, nonyl(meth)acrylate, decyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, octadecyl(meth)acrylate, eicosyl(meth)acrylate, docosyl(meth)acrylate, and the like; hydroxypolyoxyalkylene (the number of carbon atoms in the alkylene group: 2 to 8) mono(meth)acrylates; and the like. Herein, “--(meth)acrylate” means “--acrylate” or “--methacrylate.”

Furthermore, in particular, in the case where base polymer polyol having a high content of polymers but low viscosity is intended to obtain, (b4) or (b5) is contained preferably. In particular, (b4) is contained preferably. The lower limit of the number-average molecular weight of (b4) is preferably 170, more preferably 180, particularly preferably 182, and the most preferably 185. The upper limit thereof is preferably 480, more preferably 450, particularly preferable 420, and the most preferably 400. When the number average molecular weight is not less than 160, the viscosity of polymer polyol becomes low, and it is desirable from the aspect of the handling properties of the polymer polyol and a polyurethane foam obtained using this has a good hardness.

As to the number of ethylenically unsaturated groups in (b4), not less than one ethylenically unsaturated group on average will suffice. The number is preferably 1 to 10, more preferably 1 to 2, and particularly preferably 1. In the case where the number of the ethylenically unsaturated groups is less than 1 on average, soluble components in polyols increase, thereby increasing the viscosity of a polymer polyol obtained, and further, significantly impairing the properties of a polyurethane resin formed using the same. Note here that as long as at least one (on average) ethylenically unsaturated group of (b4) is present at a terminal the other unsaturated groups can be present at terminals or at positions that are not terminals.

More specifically, examples of the foregoing ethylenically unsaturated groups include α-alkenyl groups such as (meth)acryloyl groups and allyl groups.

Furthermore, a molecular weight (X) per one double bond of (b4) is preferably not more than 490. The lower limit thereof is preferably 160, more preferably 180, and particularly preferably 185. The upper limit thereof is more preferably 480, particularly preferably 450 and the most preferably 400. In the case where it is not more than 490, a significant effect of decreasing the viscosity of polymer polyol produced by using the same can be achieved.

Here, the molecular weight (X) per one double bond is defined as shown by a formula below:
X=1000/N
where N represents an unsaturation degree of (b4) measured by the method specified in JIS K-1557 (1970).

Furthermore, (b4) usually has a solubility parameter SP of 9.5 to 13. The lower limit thereof is preferably 9.8, and more preferably 10.0. The upper limit thereof is preferably 12.5 and more preferably 12.2. In the case where SP of (b4) is not less than 9.5, a polymer polyol produced using the same has a low viscosity. Furthermore, in the case where SP is not more than 13, a hardness of polyurethane foam obtained using the polymer polyol is increased.

The SP value refers to the parameter expressed by the square root of the ratio of a cohesive energy density to a molar volume as follows:
[SP value]=(ΔE/V)^{1/2}.

In the above equation, ΔE indicates a cohesive energy density, and V indicates a molar volume. The value of V is determined by the calculation of Robert F. Fedors et al., which is described, for example, in Polymer Engineering and Science, Volume 14, pages 147 to 154.

Specific examples that preferably are used as (b4) include (b41) to (b45) shown below, since with the same, the obtained polymer polyol has a low viscosity, thereby causing an obtained polyurethane foam to have a greater hardness. Two or more thereof may be used in combination.

(b41): (poly)oxyalkylene (C in the alkylene group) ether of a terminal unsaturated alcohol (C₃-C₂₄);
(b42): compound expressed by a general formula [1] shown below;
(b43): compound expressed by a general formula [2] shown below;
(b44): compound expressed by a general formula [3] shown below;
(b45): compound expressed by a general formula [4] shown below:
   CH₂═CRCOO(AO)ₖCOCH₂COCH₃ [1]
   CH₂═CRCOO(AO)ₖ[CO(CH₂)ₛO]ₘ(AO)ₙH [2]
   CH₂═CRCO[O(CH₂ₛCO]ₘO(AO)ₙH [3]
   CH₂═CRCOO(AO)ₖ[QO(AO)ₚ]ᵣ(O)ₜH [4]
   where:
R represents a hydrogen atom or a methyl group;
A represents an alkylene group having 2 to 8 carbon atoms;
Q represents a residue obtained by removing two OH groups from dicarboxylic acid;
k represents an integer of not less than 1 that provides a number-average molecular weight of not more than 490;
n and p represent 0 or integers of not less than 1 that provide a number-average molecular weight of not more than 490;
s represents an integer of 3 to 7;
m and r are integers of not less than 1 that provide a number-average molecular weight of not more than 490; and
t represents 0 or 1.

Note here that the number-average molecular weight that “provides a number-average molecular weight of not more than 490” indicates a number-average molecular weight of the foregoing compound.

Examples of the terminal unsaturated alcohol having 3 to 24 carbon atoms in the foregoing (b41) include allyl alcohol, 1-hexen-3-ol, etc. The number of oxyalkylene units in (b41) is usually 1 to 9, preferably 1 to 5, and more preferably 1 to 3.

In the foregoing general formulae [1] to [4], A represents an alkylene group having 2 to 8 carbon atoms, an AO unit is usually formed by adding an alkylene oxide having 2 to 8 carbon atoms, and k, n, and p are equivalent to the numbers of added moles of the alkylene oxide, respectively. Furthermore, (poly)oxyalkylene units having 2 to 8 carbon atoms in the alkylene group of (b41) are also usually formed by adding an alkylene oxide having 2 to 8 carbon atoms.

Examples of the foregoing alkylene oxide include those mentioned in the description about the polyol (A) as alkylene oxides to be added to an active hydrogen-containing compound. The alkylene oxide is preferably PO and/or EO.

k is preferably 1 to 7, more preferably 1 to 5, and particularly preferably 1. n is preferably either 0 or 1 to 7, more preferably either 0 or 1 to 5, and particularly preferably 0. p is preferably either 0 or 1 to 6.

Examples of Q include a residue obtained by removing two OH groups from a dicarboxylic acid. Preferable examples of the dicarboxylic acid are those having 4 to 10 carbon atoms. More specifically, the examples include phthalic acid (including isophthalic acid and terephthalic acid), maleic acid, fumaric acid, and succinic acid. Phthalic acid and succinic acid are preferred.

The parts of the [CO(CH₂)ₛO] unit and the [O(CH₂)ₛCO] unit usually are formed by adding lactone. s is preferably 4 to 6, and more preferably 5. m is preferably 1 to 5, more preferably 1 to 3, and particularly preferably 2.

Furthermore, r is preferably 1 to 5, more preferably 1 or 2, and particularly preferably 1.

Among these (b41) to (b45), (b41) and (b42) are more preferred, and (b41) is particularly preferred.

As to specific examples of (b41) to (b45), examples of (b41), for instance, include 1 to 5-mole PO and/or EO adducts of allyl alcohol.

Examples of (b42) include an acetoacetic ester of a compound obtained by adding 1 to 5 moles of PO and/or EO to 1 mole of (meth)acrylic acid.

Examples of (b43) include a compound obtained by adding 1 to 5 moles of ε-caprolactone to a compound obtained by adding 1 to 5 moles of PO and/or EO to 1 mole of a (meth)acrylic acid, and a compound obtained by further adding 1 to 5 moles of PO and/or EO to 1 mole of the foregoing compound.

Examples of (b44) include a compound obtained by adding 1 to 5 moles of ε-caprolactone to 1 mole of a (meth)acrylic acid, and a compound obtained by further adding 1 to 5 moles of PO and/or EO to 1 mole of the foregoing compound.

Examples of (b45) include: a monoester of a compound obtained by adding 1 to 5 moles of PO and/or EO to 1 mole of a (meth)acrylic acid with the equal number of moles of succinic acid; a monoester of a compound obtained by adding 1 to 5 moles of PO and/or EO to 1 mole of a (meth)acrylic acid with the equal number of moles of maleic acid or fumaric acid; a compound obtained by preparing a monoester of a compound obtained by adding 1 to 5 moles of PO and/or EO to 1 mole of a (meth)acrylic acid with the equal number of moles of phthalic acid, then adding 1 to 5 moles of EO and/or PO to 1 mole of the foregoing monoester; and a monoester of the foregoing compound with the equal number of moles of phthalic acid.

Examples of (b5) include ester compounds formed from an unsaturated carboxylic acid (p) and a glycol (q), and ester compounds formed from an unsaturated alcohol (r) and a carboxylic acid (s) that are described in WO01/009242. Ester compounds formed from (p) and (q) are preferred.

The unsaturated carboxylic acid (p) is a carboxylic acid having double bonds (non-conjugated in the case of two or more double bonds) in the molecule or a derivative thereof e.g. a carboxylic acid having 3 to 24 carbon atoms, such as acrylic acid, methacrylic acid, maleic acid, fumaric acid, itaconic acid, citraconic acid and oleic acid; an acid anhydride such as maleic anhydride, itaconic anhydride and citraconic anhydride, and the like. Preferably, one or more carboxylic acids selected from maleic acid, fumaric acid and itaconic acid, or derivatives thereof are used.

Carboxylic acids other than those described above also can be used simultaneously as needed. Examples of such carboxylic acids are aliphatic carboxylic acids having 2 to 24 carbon atoms, such as acetic acid, propionic acid, stearic acid, succinic acid, and adipic acid; aromatic carboxylic acids having 7 to 18 carbon atoms, such as isophthalic acid and terephthalic acid; and alicyclic carboxylic acids having 6 to 20 carbon atoms, such as 1,4-cyclohexanedicarboxylic acid and tetrahydrophthalic acid.

As the glycol (q), the polyhydric alcohols and polyhydric phenols, the alkylene oxides having 2 to 8 carbon atoms described above, and alkylene oxide adduct of polyhydric alcohol or polyhydric phenol can be used. Preferably, alkylene glycols such as ethylene glycol, diethylene glycol polyethylene glycol propylene glycol, polypropylene glycol 1,4-butanediol, 1,6-hexanediol and neopentyl glycol, and alkylene oxides such as EO, PO, BO, and the like are used.

The number average molecular weight of (b5) is generally not less than 500, preferably not less than 550, and particularly preferably 800 to 10000. Furthermore, a molecular weight (X) per one double bond of (b5) is generally not more than 1200, preferably not more than 1150 and particularly preferably in the range from 100 to 1050.

Examples of ethylenically-unsaturated monomer (b6) other than (b1) to (b5) include (meth)acrylamide; vinyl group-containing carboxylic acids and derivatives thereof such as (meth)acrylic acid; aliphatic hydrocarbon monomers, such as ethylene and propylene; fluorine-containing vinyl monomers, such as perfluorooctylethyl methacrylate and perfluorooctylethyl acrylate; nitrogen-containing vinyl monomers other than those described above, such as diaminoethyl methacrylate and morpholinoethyl methacrylate; vinyl-modified silicone; cyclic olefin compounds, such as norbornene, cyclopentadiene and norbornadiene; and the like.

As (b), from the viewpoint of the physical property of polyurethane obtained by using polymer polyol, (b) including (b1) or (b2), and additionally (b4) if necessary is preferred. (b) including acrylonitrile and/or styrene, and additionally (b4) if necessary is further preferred. In (b), the total amount of acrylonitrile and styrene is preferably not less than 50 mass %. The lower limit thereof is more preferably 60 mass % and particularly preferably 80 mass %. The upper limit thereof is more preferably 98 mass % and particularly preferably 95 mass %.

Radical polymerization for obtaining the base polymer polyol can be carried out in the same way as the polymerization of conventional polymer polyols. For example, the method of polymerizing an ethylenically unsaturated monomer (b) in a polyol (A) containing a dispersant (E) in the presence of a polymerization initiator (the method described in U.S. Pat. No. 3,383,351, etc.) may be employed.

Furthermore, the polymerization can be carried out either in batch or continuous systems under atmospheric pressure or increased pressure, or under reduced pressure. A diluent (D) and a chain transfer agent can be used as needed.

Components used in radical polymerization will be described below.

The foregoing dispersant (E) is not particularly limited, and conventional dispersants, etc. described below, which are used in polymer polyols, can be employed.

For example, (i) macromer type dispersants obtained by reacting polyol with ethylenically-unsaturated compound, e.g. a modified polyether polyol containing vinyl group having 2-6 times weight-average molecular weight of polyol having a mass average molecular weight of 500 to 10000 (see, for example, JP 08-333508A), and such a modified polyether polyol is obtained by reacting at least a part of a hydroxy group of the polyol with a methylene dihalide and/or an ethylene dihalide to increase its molecular weight, further reacting the reacted product with a vinyl group containing compound such as (meth)acrylic acid or derivative thereof [for example, glycidyl(meth)acrylate], (anhydride)malic acid, etc.; (ii) graft-type dispersants obtained by combining a polyol with an oligomer, such as a graft polymer having two or more segments (polyoxyalkylene ether group having number-average molecular weight of 88 to 750, etc) with an affinity for polyols as side chains, in which the difference between the solubility parameter of the side chains and the solubility parameter of a polyol is not more than 1.0, and having a segment (vinyl polymer having number-average molecular weight of 1,000 to 30,000, etc.) with an affinity for polymers as a main chain, in which the difference between the solubility parameter of the main chain and the solubility parameter of a polymer formed from the vinyl monomer (b) is not more than 2.0 (e.g. JP 05(1993)-059134 A); (iii) high molecular polyol type dispersants, e.g. a modified polyol obtained by reacting at least a portion of the hydroxyl groups of a polyol having an average molecular weight of 500 to 10,000 with a methylene dihalide and/or an ethylene dihalide to increase its molecular weight to have 2-6 times the weight-average molecular weight of the aforementioned polyol (e.g. JP 07(1995)-196749 A); and (iv) oligomer type dispersants, e.g. a vinyl oligomer (such as acrylonitrile/styrene copolymer) with a weight-average molecular weight of 1,000 to 30,000, at least a portion of which being soluble in polyols, and a dispersant comprising both this oligomer and the modified polyether polyol containing a vinyl group described for (i) above (e.g. JP 09(1997)-77968 A); and the like.

Among these, the types (i) and (iv) are preferred. In any case, it is preferable that (E) has a number-average molecular weight of 1,000 to 10,000.

Furthermore, the amount of (E) used in the case where such a conventional dispersant is used as (E) is preferably not more than 15 mass %, more preferably not more than 10 mass %, and particularly preferably from 0.1 to 8 mass %, based on the mass of (b).

Apart from these conventional dispersants, reactive dispersants (E1), which will be described later, may be used as the dispersant (E), and they are particularly preferred.

The reactive dispersant (E1) is made of an unsaturated polyol having a nitrogen-containing bond, which is formed by bonding a substantially saturated polyol (a) with a monofunctional active hydrogen compound (e) having at least one polymerizable unsaturated group via a polyisocyanate (f). “Substantially saturated” herein denotes that the unsaturation degree measured by the measuring method specified in JIS K-1557 (1970) is not more than 0.2 meq/g (preferably not more than 0.08 meq/g).

As (a) constituting the reactive dispersant (E1), those that are the same as described in the above mentioned (A) can be used. (a) may be different from (A) or (a) may be the same as (A).

The number of hydroxyl groups in one molecule of the polyol (a) is at least two, and preferably two to eight, more preferably three to four. The hydroxyl equivalent of (a) is preferably 1,000 to 3,000, and more preferably 1,500 to 2,500.

The compound (e) used for obtaining (E1) is a compound having one active hydrogen-containing group and at least one polymerizable unsaturated group. Examples of the active hydrogen-containing group include a hydroxyl group, an amino group, an imino group, a carboxyl group, an SH group, etc., among which the hydroxyl group is preferred.

The polymerizable unsaturated group of (e) preferably has a polymerizable double bond, and the number of the polymerizable unsaturated groups in one molecule is preferably one to three, and more preferably one. More specifically, preferred as the compound (e) is an unsaturated monohydroxy compound having one polymerizable double bond.

Examples of the foregoing unsaturated monohydroxy compound include, for instance, monohydroxy-substituted unsaturated hydrocarbons, monoesters of unsaturated monocarboxylic acids and dihydric alcohols, monoesters of unsaturated dihydric alcohols and monocarboxylic acids, phenols having alkenyl side chain groups, and unsaturated polyether monools.

Examples of the monohydroxy-substituted unsaturated hydrocarbon include: alkenol having 3 to 6 carbon atoms such as (meth)allyl alcohol, 2-buten-1-ol, 3-buten-2-ol, 3-buten-1-ol, etc.; and alkynol, for instance, propargyl alcohol.

Examples of the monoesters of unsaturated monocarboxylic acids and dihydric alcohols include monoesters of: unsaturated monocarboxylic acids each having 3 to 8 carbon atoms, for instance, acrylic acid, methacrylic acid, chrotonic acid, or itaconic acid; and the above-described dihydric alcohols (dihydric alcohols having 2 to 12 carbon atoms such as ethylene glycol, propylene glycol, and butylene glycol). Specific examples of the foregoing monoesters include 2-hydroxy ethyl acrylate, 2-hydroxy ethyl methacrylate, 2-hydroxy propyl acrylate, 2-hydroxy propyl methacrylate, 2-hydroxy butyl acrylate, 4-hydroxy butyl acrylate, etc.

Examples of the monoesters of unsaturated dihydric alcohols and monocarboxylic acids include monoesters of unsaturated dihydric alcohols having 3 to 8 carbon atoms and monocarboxylic acids having 2 to 12 carbon atoms, for instance, acetic acid monoester of butene diol.

Examples of the phenol having an alkenyl side chain group include phenols each having an alkenyl side chain group having 2 to 8 carbon atoms, such as oxystyrene, hydroxy-α-methyl styrene, etc.

Examples of the unsaturated polyether monool include 1 to 50-mole alkylene oxide (having 2 to 8 carbon atoms) adducts of the aforementioned monohydroxy-substituted unsaturated hydrocarbon or the aforementioned phenol having the alkenyl side chain group (for instance, polyoxyethylene (having a degree of polymerization of 2 to 10) monoallyl ether).

The examples of the compound (e) other than the unsaturated monohydroxy compound include the following.

Examples of the compound (e) having an amino group or an imino group include mono- and di-(meth)allyl amine, amino alkyl (having 2 to 4 carbon atoms) (meth)acrylate [e.g., amino ethyl(meth)acrylate], and monoalkyl (having 1 to 12 carbon atoms) amino alkyl (having 2 to 4 carbon atoms) (meth)acrylate [e.g., monomethyl amino ethyl-methacrylate]; examples of the compound (e) having a carboxyl group include the aforementioned unsaturated monocarboxylic acids; and examples of the compound (e) having an SH group include compounds corresponding to the aforementioned unsaturated monohydroxy compounds (in which SH substitutes for OH).

Examples of the compound (e) having not less than two polymerizable double bonds include poly(meth)allylethers of the aforementioned polyhydric alcohols having a valence of 3, 4 to 8, or more, or polyesters of the above alcohols with the aforementioned unsaturated carboxylic acids [e.g., trimethylol propane diallylether, pentaerythritol trialylether, glycerin di(meth)acrylate, etc.]

Among these compounds, preferred are the alkenols having 3 to 6 carbon atoms, the monoesters of unsaturated monocarboxylic acids having 3 to 8 carbon atoms and dihydric alcohols having 2 to 12 carbon atoms, and the phenols having alkenyl side chain groups. More preferred are monoesters of (meth)acrylic acids with ethylene glycol, propylene glycol, or butylene glycol; allyl alcohol; and hydroxy α-methyl styrene. Particularly preferred is 2-hydroxy ethyl (meth)acrylate.

Furthermore, though the molecular weight of (e) is not particularly limited, it is preferably not more than 1,000, and particularly preferably not more than 500.

The polyisocyanate (f) is a compound having at least two isocyanate groups, and examples of the same include aromatic polyisocyanates, aliphatic polyisocyanates, alicyclic polyisocyanates, araliphatic polyisocyanates, modification products of these polyisocyanates (modification products having a urethane group, a carbodiimido group, an allophanate group, a urea group, a biuret group, an isocyanurate group, or an oxazolidon group, etc.), and mixtures of two or more thereof.

Examples of the aromatic polyisocyanates include aromatic diisocyanates having 6 to 16 carbon atoms (excluding carbon atoms contained in NCO groups; this applies to the polyisocyanates mentioned below), aromatic trisocyanates having 6 to 20 carbon atoms, crude products of these isocyanates, etc. More specifically, the examples include 1,3- or 1,4-phenylene diisocyanates, 2,4- and/or 2,6-tolylene diisocyanates (TDI), crude TDI, 2,4′- and/or 4,4′-diphenyl methane diisocyanate (MDI), crude MDI [products of crude diaminodiphenyl methane with phosgene where the crude diaminodiphenyl methane is a condensation product of formaldehyde with aromatic amine (aniline) or a mixture of the same; or is a mixture of diaminodiphenyl methane and a small amount (e.g., 5 to 20 mass %) of a polyamine having three or more functional groups; polyallyl polyisocyanate (PAPI), etc.], naphthylene-1,5-diisocyanate, triphenyl methane-4,4′,4″-triisocyanate, etc.

Examples of aliphatic polyisocyanates include aliphatic diisocyanates having 2 to 18 carbon atoms. More specifically, the examples include 1,6-hexamethylene diisocyanate, 2,2,4-trimethylhexamethylene diisocyanate, lysine diisocyanate, etc.

Examples of alicyclic polyisocyanates include alicyclic diisocyanates having 4 to 16 carbon atoms. More specifically, the examples include isophorone diisocyanate, 4,4-dicyclohexyl methane diisocyanate, 1,4-cyclohexane diisocyanate, norbornane diisocyanate, etc.

Examples of araliphatic isocyanates include araliphatic diisocyanates having 8 to 15 carbon atoms. More specifically, the examples include xylylene diisocyanate, α,α,α′, α′-tetramethyl xylylene diisocyanate, etc.

Examples of modified polyisocyanates include urethane-modified MDI, carbodiimide-modified MDI, sucrose-modified TDI, castor oil-modified MDI, etc.

Among these, aromatic diisocyanates are preferred, and 2,4- and/or 2,6-TDI is more preferred.

The nitrogen-containing bond of the reactive dispersant (E1) is generated by reaction of the isocyanate group with an active hydrogen-containing group. In the case where the active hydrogen-containing group is a hydroxy group, a urethane bond is generated principally, while in the case where it is an amino group, a urea bond is generated principally. An amide bond is generated in the case of a carboxyl group, while a thiourethane bond is generated in the case of a SH group. In addition to these groups, another bond, for instance, a biuret bond, an allophanate bond, etc., may be generated.

These nitrogen-containing bonds generally are classified into two kinds; those generated by reaction of a hydroxy group of the substantially saturated polyol (a) with an isocyanate group of the polyisocyanate (f); and those generated by reaction of an active hydrogen-containing group of the unsaturated monofunctional active hydrogen compound (e) with an isocyanate group of (f).

From a viewpoint of the dispersion stability of the polymer polyol an average of the number of the hydroxy groups in one molecule of (E1) is usually not less than 2, preferably 2.5 to 10, and more preferably 3 to 7. An average of the number of the unsaturated groups in one molecule of (E1) is preferably 0.8 to 2, and more preferably 0.9 to 1.2.

Furthermore, from the viewpoint of the dispersion stability, a hydroxyl equivalent of (E1) is preferably 500 to 10,000, more preferably 1,000 to 7,000, and particularly preferably 2,000 to 6,000.

Furthermore, from the viewpoint of the dispersion stability and the ease of handling, a number-average molecular weight of (E1) (measured by a terminal group quantitative analysis) is preferably 5,000 to 40,000. The lower limit thereof is preferably 10,000, and particularly preferably 15,500 and the upper limit thereof is preferably 30,000 and particularly preferably 25,000.

Furthermore, (E1) preferably has a viscosity of 10,000 to 50,000 mPa·s/25° C., and more preferably 15,000 to 35,000 mPa·s/25° C. In the case where the viscosity is in the foregoing range, the polymer has better dispersibility, thereby allowing the polymer polyol obtained with use of (E1) to have a lower viscosity and providing more ease of handling.

A method for producing the reactive dispersant (E1) by employing these materials is not particularly limited.

Examples of preferable methods include a method of adding a polyisocyanate (f) to a mixture of an unsaturated monofunctional active hydrogen compound (e) and a substantially saturated polyol (a) and reacting the same in the presence of a catalyst as needed, and a method of reacting (e) and (f) in the presence of a catalyst as needed to produce an unsaturated compound having an isocyanate group and reacting the same with (a). The latter method is most preferred since the method provides an unsaturated polyol having a nitrogen-containing bond, from which a minimum of by-products such as compounds having no hydroxy group are generated.

Alternatively, (E1) may be formed by a method in which, in place of (e) or (a), a precursor of the same is reacted with (f) and thereafter the precursor portion is modified [e.g., after reacting the aforementioned precursor with isocyanate, the obtained reaction product is reacted with an unsaturated monocarboxylic acid or an esterforming derivative of the same so as to introduce an unsaturated group, or after reacting the aforementioned precursor with isocyanate, the obtained reaction product is coupled (dimerized) using alkylene dihalide, or dicarboxylic acid, so as to form (E1)].

Examples of the catalyst for the foregoing reaction include generally used urethane catalysts such as tin-based catalysts (dibutyltin dilaurate, stannous octoate, etc.), other metal-based catalysts (tetrabutyl titanate, etc.), amine-based catalyst (triethylene diamine, etc.). Among these, tetrabutyl titanate is preferred.

An amount of the catalyst is preferably 0.0001 to 5 mass %, and more preferably 0.001 to 3 mass % based on the mass of a reaction mixture.

As to the reaction ratio of these three components, an equivalent ratio of the active hydrogen-containing groups of (e) and (a) to the isocyanate groups of (D is preferably (1.2 to 4): 1, more preferably (1.5 to 3): 1 based on a total amount of the components used in the reaction.

Furthermore, an amount of (e) used in the reaction is preferably less than 2 parts by mass, and more preferably 0.5 to 1.8 parts by mass, with respect to 100 parts by mass of (a).

Note here that by using a greatly excessive amount of (a) that is larger than the amount reacting with (f), a mixture of (E1) and (a) may be formed and used as a part of the polyol (A) without removing unreacted (a).

The reactive dispersant (E1) obtained by the above-mentioned method may be a single compound. In many cases, however, it is a mixture of various compounds such as those expressed by a general formula [5] shown below. 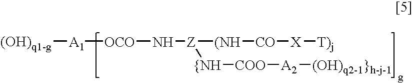
wherein
Z represents a residue of (f) having a valence of h (h is an integer of not less than 2);
T represents a residue of (e) (having a polymerizable unsaturated group);
A₁ represents a residue of a polyol having a valence of q₁ [(a) or OH prepolymer derived from (a) and (f)], and A₂ represents a residue of a polyol having a valence of q₂ [(a) or OH prepolymer derived from (a) and (f)] (q₁ and q₂ are integers of not less than 2); and
X represents a single bond, O, S, or 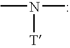
where:
   T″ represents H or an alkyl group having 1 to 12 carbon atoms;
   g represents an integer of not less than 1;
   j represents an integer of not less than 1;
   q₁−g≧0;
   h−j−1≧0; and
   the total number of OH groups is not less than 2.

In other words, the reactive dispersant (E1) includes one polyol (a) and one compound (e) that are bonded with each other via one polyisocyanate (f), a plurality of compounds (e) and one polyol (a) that are bonded with each other via one polyisocyanate (f) for each (e), polyols (a) and compounds (e), not less than three in total, that are bonded with each other via a plurality of polyisocyanates (f), etc. Furthermore, in addition to these, a plurality of polyols (a) bonded with each other via polyisocyanates (f) (a polyol having no unsaturated group, which contains a nitrogen-containing bond) and a plurality of compounds (e) bonded with each other via polyisocyanates (f) (an unsaturated compound having no hydroxyl group, which contains a nitrogen-containing bond) may be formed as by-products, and also, the reactive dispersant (E1) may contain unreacted (a) and (e) in some cases.

These mixtures may be used as dispersants without any modification, but those containing a minimum of polyols having no unsaturated group, which contain a nitrogen-containing bond, or unsaturated compounds having no hydroxyl group, which contain a nitrogen-containing bond, are preferred, and they may be used after removing the impurities that are removable.

Furthermore, since unsaturated groups in (E1) are present at terminals or in the vicinity of terminals of molecular chains of the polyol, they are copolymerizable with monomers easily.

A dispersant (E1) preferably is obtained by reacting (a), (e), and (f) so that K, indicative of an average of a ratio of the number of unsaturated groups to the number of nitrogen-containing bonds derived from NCO groups in one molecule of (f), which is calculated from a formula (4), is 0.1 to 0.4:
K=[number of moles of (e)×number of unsaturated groups of (e)]/[number of moles of (f)×number of NCO groups of (f)] (4)

The value of K is more preferably 0.1 to 0.3, and particularly preferably 0.2 to 0.3. In the case where the value of K is in the foregoing range, a particularly excellent dispersion stability for the polymer polyol can be obtained.

As to the composition ratio of a polyol (A) and a reactive dispersant (E1) when a polymer polyol is formed, 0.5 to 50 parts by mass of (E1) preferably is used with respect to 100 parts by mass of (A). The lower limit is further preferably 0.8 parts by mass, and particularly preferably 1 part by mass. The upper limit is further preferably 15 parts by mass and particularly preferably 10 parts by mass. When (E1) is not more than 50 parts by mass, the viscosity of polymer polyol is not increased and when (E1) is not less than 0.5 parts by mass, the dispersing property is excellent.

The reactive dispersant (E1) has an extremely excellent dispersant stability for the polymer polyol obtained by using the same. In particular, it is suitably used for producing polymer polyol with high concentration (for example, content of polymers 40 to 75 mass %) where (b4) is used as the ethylenically unsaturated compound (b), and polymer polyol with lower viscosity can be obtained.

As the polymerization initiator used for polymerizing (b), compounds that form a free radical to initiate polymerization may be used. Examples of the compounds include azo compounds, such as 2,2′-azobisisobutyronitrile, 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), dimethyl-2,2′-azobis(2-methyl propionate), 2,2′-azobis[2-(hydroxymethyl)propionitrile] and 1,1′-azobis(1-acetoxy-1-phenylethane); organic peroxides such as dibenzoyl peroxide, dicumyl peroxide, bis(4-t-butylcyclohexyl) peroxidicarbonate, benzoyl peroxide, lauroyl peroxide and persuccinic add; and inorganic peroxides, such as persulfate and perborate. Combinations of two or more thereof also may be used.

The amount of the polymerization initiator used is usually from 0.05 to 20 mass %, preferably 0.1 to 15 mass %, particularly preferably from 0.2 to 10 mass %, based on the amount of (b) used. When the amount of the polymerization initiator used is 0.05 to 20 mass %, the polymerization degree of (b) in the polymer polyol is sufficiently high, and also the molecular weight is high. Thus, it is advantageous in that a polyurethane foam having a sufficient compressive hardness can be obtained.

Examples of the diluent (D) used in the radical polymerization include: aromatic hydrocarbon solvents such as toluene and xylene; and saturated aliphatic hydrocarbon solvents having 5 to 15 carbon atoms such as hexane and heptane.

The amount of the diluent used is preferably not more than 50 mass %, and further preferably not more than 40 mass % based on the amount of (b) used. The (D) used is preferably removed therefrom by vacuum stripping after polymerization.

Furthermore, the (D) may be added in the polymer polyol of the present invention as needed so as to lower the viscosity. Examples of (D) to be contained in the polymer polyol include: the aforementioned unsaturated aliphatic hydrocarbon solvents; aromatic hydrocarbon solvents; and fire retardants having a low viscosity (not more than 100 mPa·s/25° C.), for instance, tris(chloroethyl)phosphate, tris(chloropropyl)phosphate, etc.

The content of the (D) in the polymer polyol of the present ivention is preferably not more than 2 mass %, and more preferably not more than 1 mass %.

Examples of the chain transfer agent include alkylmercaptans, such as dodecylmercaptan and mercaptoethanol.

The amount of the chain transfer agent used is usually not more than 2 mass % and preferably not more than 0.1 mass % based on the amount of (b) used.

Note here that the base polymer polyol herein denotes a polymer polyol obtained by polymerizing an ethylenically-unsaturated monomer in polyol in the presence of polymerization initiator and stably dispersing polymer fine particles in the polyol. This means the polymer polyol in which the operation for reducing the residual monomer is not carried out.

In the second invention, as the organic solvent (II), organic solvent (IIa) having a boiling point of 60 to 150° C. and SP value of 7 to 14 is used. The boiling point is more preferably 63 to 90° C. and SP value is more preferably 9 to 14; and particularly preferably 12 to 13.9. When the SP value is less than 7 or more than 14, the effect of reducing the residual monomer is insufficient. Furthermore, when the boiling point is less than 60° C. or more than 150° C., the effect for reducing the monomers is insufficient.

Examples of (IIa) include alcohol having 1 to 4 carbon atoms (methanol, ethanol, isopropanol, butanol, etc.), aromatic hydrocarbon (xylene, toluene, etc.), aliphatic or alicyclic hydrocarbon (hexane, heptane, cyclohexane, etc.) and ketone (methyl ethyl ketone, etc.). Among them, alcohol having 1 to 4 carbon atoms and aromatic hydrocarbon are preferred, a solvent including alcohol having 1 to 4 carbon atoms is more preferable, and particularly preferably methanol and a combination of methanol and xylene.

A method for mixing (IIa) and base polymer polyol may be carried out by adding (IIa) into the prepared base polymer polyol once or may be carried out by mixing (IIa) into the prepared base polymer polyol two or more times. Alternately, on the contrary, base polymer polyol may be added into (IIa), but the former is preferred.

Furthermore, when the organic solvent (II) includes an organic solvent (II-1) having a SP value of 7 to 14 (cal/cm³)^{1/2} and a boiling point that satisfies the following relational formula (1), it is preferable that (II-1) and the base polymer polyol are preferably mixed in a manner in which the (II-1) is mixed after the base polymer polyol is produced. However, the method is not particularly limited thereto. For example, during the formation of base polymer polyol, the material corresponding to the solvent (II-1) as diluent (D) or chain transfer material is used and may be used as at least a part of (II-1) without removing the material as it is (the first invention).
850/s≦bp≦1100/s (1),
880/s≦bp≦1050/s (1′),
where
s represents an SP value of the organic solvent, and
bp represents a boiling point of the organic solvent.

The SP value of the (II-1) is more preferably 9 to 14 and particularly preferably 12 to 13.9. The boiling point more preferably satisfies the above-mentioned relational formula (1′). When the SP value and boiling point are within the above-mentioned range, the sufficient effect of reducing monomer can be obtained.

Specific examples of (II-1) include methanol, ethanol, isopropanol, and the like. Amore preferable example is methanol.

Both in the first invention and the second invention, it is preferable that the organic solvent (II) includes the above-mentioned (II-1) and an organic solvent (II-2) having a SP value of 9 to 11 (cal/cm³)^{1/2} and a boiling point that satisfies the following relational formula (II-2), and the content of (II-1) in the (II) is 70 to 99.9 mass % and the content of (II-2) in the (II) is 0.1 to 30 mass %, because the effect for reducing monomers can be improved more.
1100/s≦bp≦150 (2),
1120/s≦bp≦145 (2′),
where
s represents an SP value of the organic solvent, and
bp represents a boiling point of the organic solvent.

The SP value of (II-2) is more preferably 9.1 to 10.5. The boiling point more preferably satisfies the above-mentioned relational formula (2′).

The content (II-1) in the (II) is more preferably 80 to 99 mass % and the content (II-2) is more preferably 1 to 20 mass %,

(II-2) may be mixed with the base polymer polyol after it was produced. Alternately, at least a part of (II-2) may be used as a diluent (D) or chain transfer material during production of base polymer polyol. Furthermore, (II-1) and (II-2) may be mixed with the base polymer polyol simultaneously or may be separately.

Specific examples of (II-2) include xylene, toluene, and the like. Amore preferable example is xylene.

The amount of (II) used is generally not more than 3 mass %, and preferably 3 to 25 mass % based on the base polymer polyol. The lower limit thereof is more preferably 4 mass % and particularly preferably 5 mass %. The upper limit thereof is preferably 20 mass % and particularly preferably 16 mass %. When the amount of (II) is less than 3 mass %, the effect of reducing monomer is insufficient. Furthermore, the amount of (II) of not more than 25 mass % is preferred because the time for removing is not so long.

The conditions for removing the unreacted (b) together with (II) is not particularly limited as long as they are effective conditions for reducing (b). From the viewpoint of removing efficiency, removing under reduced pressure is preferred. An example of the method includes stripping under stirring by using an oar type mixing blade or stripping by using a film evaporator, for 1 to 10 hours under the conditions at temperatures of 110 to 150° C. and reduced pressure of 1 to 100 (preferably 5 to 50) torr [133.3 to 13330 Pa (preferably 666.5 to 6665 Pa)].

The content of polymer (B) which is a polymer of (b) in the polymer polyol obtained by the production process of the present invention is preferably 25 to 75 mass %. The lower limit thereof is more preferably 35 mass %, particularly preferably 40 mass % and most preferably 50 mass %. The upper limit thereof is more preferably 70 mass %. When the content (13) is not less than 25 mass %, sufficient hardness can be obtained when used as a raw material of polyurethane foam. When the content (B) is not more than 75 mass %, the viscosity does not become so high and handling becomes easily.

The particle size of the polymer (B) is preferably not more than 100 μm. The lower limit thereof is preferably 0.01 μm, and particularly preferably 0.3 μm. The upper limit thereof is more preferably 10 μm and particularly preferably 3 μm. When particles of more than 100 μm are contained, the clogging may occur in a strainer, etc. when the polymer polyol is filled. Herein, when the particle size is not more than 100 μm, when polymer polyol containing (B) is filtered at normal pressure through the wire net with the opening size of 100 μm, substantially the entire amount can pass.

As to the particle size of (B), the content (volume base) of particles with particle size of 0.01 to 10 μm is preferably not less than 95 mass %; and more preferably the content of particles with particle size of 0.3 to 3 μm is 95 mass %. The particle size herein denotes a volume based particle size measured by a laser diffraction/light scattering distribution particle size measuring apparatus.

Furthermore, as to the content (by gas chromatograph) of residual monomers in the polymer polyol from the viewpoint of the working environment in which the polyurethane foam is formed by using polymer polyol, it is preferable that the content of acrylonitrile is not more than 100 ppm and the content of styrene is not more than 150 ppm. The content of acrylonitrile is more preferably not more than 50 ppm, and particularly preferably not more than 5 ppm. The content of styrene is more preferably not more than 70 ppm, and particularly preferably not more than 15 ppm. It is preferable that the total content of acrylonitrile and styrene is not more than 250 ppm. Furthermore, it is more preferably not more than 120 ppm and particularly preferably not more than 20 ppm. Note here that the detail of the method for gas chromatograph is based on the following Examples.

According to the production process of the present invention, the content of monomers can be reduced efficiently without affecting the polymer particles, such as causing a problem such as agglomeration. Therefore, with the method of the present invention, it is possible to obtain a polymer polyol obtained by dispersing 40 to 75 mass % of polymer (B) in 25 to 60 mass % of polyol (A), wherein (B) is a polymer (B1) that can be obtained by polymerizing the ethylenically unsaturated monomer having the content of acrylonitrile and/or styrene is not less than 50 mass %, and that has the particle size of not more than 100 μm and the content of particles with the particle size of 0.01 to 10 μm is not less than 95 mass %, wherein the total content of acrylonitrile and styrene is not more than 20 ppm.

The polymer polyol of the present invention can be suitably used as at least a part of the polyol component in producing the foam type or non-foam type polyurethane resin by reacting the polyol component and polyisocianate component [aforementioned example of (f), etc] in the presence or absence of foaming agent (such as water).

### EXAMPLES

The present invention is described further in detail with reference to the following examples. However, the present invention is not limited to these examples in any way. In the following, the values of parts, percentage, and ratio indicate those of parts by mass, mass percentage, and mass ratio, respectively.

Compositions, etc. of materials used in Preparation Examples, Examples and Comparative Examples expressed by abbreviations, are as follows.

(1) Polyol

Polyol (a1): polyol obtained by adding 46 moles on average of propylene oxide (PO) to glycerin and subsequently adding 6 moles on average of ethylene oxide (EO), the polyol having a number-average molecular weight of 3000 and hydroxyl equivalent of the polyol of 1000.

Polyol (a2): polyol obtained by adding 104 moles on average of propylene oxide (PO) to pentaerythritol and subsequently adding 19 moles in average of ethylene oxide (EO), the polyol having a number-average molecular weight of 7000 and hydroxyl equivalent of the polyol of 1750.

(2) Ethylenically Unsaturated Compound

AN: acrylonitrile
St: styrene
   (3) Monofunctional Active Hydrogen Compound Having Polymeric Unsaturated Group
HEMA: 2-hydroxy ethyl methacrylate
   (4) Polymerization Initiater
AIBN: 2,2′-azobisisobutyronitrile
   (5) Catalyst
TBT: tetrabutyl titanate [manufactured by Nacalai Tesque, Inc.]
   (6) Polyisocyanate
TDI: “CORONATE P80” [manufactured by NIPPON POLYURETHANE INDUSTRY CO., LTD.]

### Preparation Example 1

### Production of a Reactive Dispersant (E1)

Into a four-neck flask equipped with a thermoregulator, a vacuum mixing blade, and a dropping funnel, 28 parts of TDI and 0.01 part of TBT were added, and cooled at 30° C., and subsequently 9 parts of HEMA were dropped over 2 hours, while the reaction temperature was maintained at 40 to 50° C. Then, the reaction liquid was put into 963 parts of a polyol (a2) that previously was placed in a four-neck flask equipped with a thermoregulator, a mixing blade, and a dropping funnel, and stirred for 4 hours at a reaction temperature of 80 to 90° C. It was confirmed by infrared absorption spectrum that no unreacted isocyanate group was present, and a reactive dispersant (E-1) was obtained.

(E-1) had a hydroxyl value of 20 and a viscosity of 20000 mPa·s/25° C., and a ratio of the number of unsaturated groups to the number of nitrogen-containing bonds was 0.22.

### Preparation Example 2

### Production of Base Polymer Polyol-1

Into a four-neck flask equipped with a thermoregulator, a vacuum mixing blade, a dropping pump, a pressure reducing device, a Dimroth cooling tube, and an inlet and an outlet for nitrogen, 30 parts of a1, 7 parts of xylene, and 1 part of E-1 were added, and after substituting nitrogen for the air in the flask, heated at 130° C. in the nitrogen atmosphere while stirring (until the polymerization was completed). Then, a material previously prepared by mixing 4 parts of a 2.2-mole propylene oxide adduct of allyl alcohol (Mn=186, SP=10.2), 15 parts of AN, 34 parts of St, and 13 parts of a1 and a material previously prepared by mixing 8 parts of a1 and 1 part of AIBN, were dropped continuously over 3 hours using dropping pumps simultaneously, and polymerization was carried out at 130° C. Furthermore, unreacted monomers were removed by stripping under reduced pressure of 20 to 30 torr (2666 to 3999 Pa) for 2 hours. Thus, a base polymer polyol-1 having a content of polymer particles of 50% and a viscosity of 5000 mPa·s (25° C.) was obtained.

The content of acrylonitrile in the obtained base polymer polyol was 300 ppm; the content of styrene in the obtained base polymer polyol was 1000 ppm and the content of xylene (boiling point: 139° C., SP value: 91) in the obtained base polymer polyol was 3500 ppm, respectively measured by the gas chromatography under the following condition.

### Preparation Example 3

### Production of a Base Polymer Polyol-2

Base polymer polyol 2 was prepared in the same manner as in Preparation Example 2 except that the monomer to be used is substituted by 4 parts of 2.2 mole propylene oxide adduct of allyl alcohol; 34 parts of AN; and 15 parts of St.

The content of acrylonitrile in the obtained base polymer polyol was 1500 ppm; the content of styrene in the obtained base polymer polyol was 800 ppm and the content of xylene in the obtained base polymer polyol was 3000 ppm, respectively measured by the gas chromatography under the following condition.

### Example 1

Into a four-neck flask equipped with a thermoregulator, a vacuum mixing blade, a dropping pump, a pressure reducing device, and an inlet and an outlet for nitrogen, base polymer polyol-1 obtained in the preparation Example 2 was added, and 15 mass % methanol (boiling point: 65° C., SP value: 13.8) was added to the polymer polyol (mass ratio of methanol:xylene was 97.7:2.3) while stirring, heated at 130° C. The inside of the reaction container was reduced to 20 to 30 torr (2666 to 3999 Pa). Then, stripping was carried out for 2 hours.

### Example 2

Polymer polyol was subjected to stripping under reduced pressure using the same condition as in Example 1 except that isopropanol (boiling point: 82° C., SP value: 11.6) (mass ratio of isopropanol:xylene was 97.7:2.3) was substituted for methanol.

### Example 3

Into a four-neck flask equipped with a thermoregulator, a vacuum mixing blade, a dropping pump, a pressure reducing device, and an inlet and an outlet for nitrogen, base polymer polyol-2 obtained in the preparation Example 3 was added, and 15 mass % methanol was added to the polymer polyol (mass ratio of methanol:xylene was 98.0:2.0) while stirring, and heated at 130° C. The inside of the reaction container was reduced to 20 to 30 torr (2666 to 3999 Pa). Then, stripping was carried out for 2 hours.

### Example 4

Polymer polyol was subjected to stripping under reduced pressure using the same condition as in Example 3 except that the content of methanol was 8 mass % with respect to polymer polyol (the mass ratio of methanol:xylene was 96.4:3.6).

### Comparative Example 1

Polymer polyol was subjected to stripping under reduced pressure using the same conditions as in Example 1 except that methanol was not used.

### Comparative Example 2

Polymer polyol was subjected to stripping under reduced pressure using the same conditions as in Example 1 except that water was used instead of methanol.

### Comparative Example 3

Polymer polyol was subjected to stripping under reduced pressure using the same conditions as in Comparative Example 1 except that the stripping time was extended to 10 hours.

The following are conditions for the stripping under reduced pressure carried out in production Examples 2 and 3, Examples and Comparative Examples.
Degree of reduction: 20 to 30 torr (2666 to 3999 Pa)
Temperature: 130° C.
Time: 2 to 10 hours
Stirring: oar type stirring blade, stirring speed: 200 rpm
Results of the performance of each of the Examples and Comparative Examples are shown in Table 1 and Table 2.

The following are evaluation methods in Table 1 and Table 2.

Viscosity: BL type viscometer, Rotor No. 3 manufactured by Tokyo Keiki Co., Ltd.

Polymer concentration: Polymer polyol was diluted with methanol so that the ratio of polymer polyol/methanol=1/3 was obtained. The polymer was separated by using a cooling centrifugal separator (18000 rpm×60 min, 20° C.) and supernatant was removed. After repeating this three times, the polymer was dried under reduced pressure (60° C.×1 hr), and the mass was measured.

<Method for Measuring Acrylonitrile and Styrene>

Gas chromatograph: GC-14B (manufactured by Shimadzu Corporation)
Column: inner diameter 4 mm φ, length 1.6 m, made of glass
Column filling material: “Polyethyleneglycol 20M” [manufactured by SHINWA CHEMICAL INDUSTRIES LTD.]
Internal side Standard material: toluene (for spectrum) [manufactured by Nacalai Tesque, Inc.]
Diluting solvent: dipropylene glycol monomethyl ether 1st grade [manufactured by Wako Pure Chemical Industries, Ltd.] (50% solution)
Injection temperature: 200° C.
Column initial temperature: 110° C.
Heating rate: 5° C./min
Final temperature of the column: 200° C.
Amount of materials to be injected: 1 μl
   <Method for Evaluating Filtration Degree>

Into a 3 liter of a flask made by SUS, polymer polyol was placed and stirred at the stirring ratio of 300 rpm and the temperature was adjusted to 60° C. The polymer polyol was pressurized at 0.1 MPa with nitrogen and the mass of polymer polyol flowing for 5 minutes from the sample discharging hole (inner diameter: 5 mm) with a 150 mesh-net attached at the lower part of the flask. For standard reference, the filtration of the base polymer polyol-1 before stripping was 300 (g/5 min) and the filtration of the base polymer polyol-2 before stripping was 340 (g/5 nm).

<Method for Measuring Average Particle Size and the Content (Volume Base) of Particle Size in the Specific Range>

The resultant polymer polyol was diluted with polyol a1 so that the transmittance of laser light was 70 to 90% and measured by the particle size distribution measuring apparatus (laser diffraction/light scattering particle size distribution measuring apparatus LA-700: manufactured by HORIBA LTD.). Note here that the value of the average particle size (μm) shows the particle size corresponding to 50% of particle size distribution based on the volume.

From the results of Table 1 and Table 2, when comparison was carried out between Examples 1 to 4 and Comparative Example 2 in which the stripping was carried out by using water, polymer polyols obtained in Examples 1 to 4 have a flowing amount after five minutes being equal to that of the flowing amount of the base polymer polyol after five minutes and show excellent filtration without deterioration of filtration occurring. On the other hand, polymer polyol obtained in Comparative Example 2 has a flowing amount after five minutes that is not more than half that of base polymer polyol, and thus the deterioration of filtration is observed and particle size is increased. Furthermore, in Comparative Examples 1 and 3 in which an organic solvent (IIa) is not used, the content of monomers is not lowered as much in the same stripping time as in the Examples. In Comparative Example 3 in which the stripping time is prolonged for reducing the monomer content, the ratio of particles with small particle size have reduced and the filtration is deteriorated.

TABLE 1

| | Example 1 | Example 2 | Example 3 | Example 4 |
|---|---|---|---|---|
| Added solvent | methanol | isopropanol | Methanol | methanol |
| at stripping | | | | |
| Solvent contained in | xylene | xylene | Xylene | xylene |
| base polymer polyol | | | | |
| Viscosity | 5000 | 5000 | 5400 | 5400 |
| (mPa · s/25° C.) | | | | |
| Polymer concentration | 50 | 50 | 50 | 50 |
| (%) | | | | |
| acrylonitrile | 1 | 1 | 1 | 2 |
| (ppm) | | | | |
| styrene | 10 | 15 | 10 | 18 |
| (ppm) | | | | |
| Total of acrylonitrile | 11 | 16 | 11 | 20 |
| and styrene | | | | |
| Stripping time | 2 | 2 | 2 | 2 |
| (hr) | | | | |
| Filtration property | 300 | 290 | 340 | 330 |
| (g/5 min) | | | | |
| Average particle size | 2.2 | 2.2 | 1.3 | 1.3 |
| (μm) | | | | |
| Content of particles | 100 | 100 | 100 | 100 |
| with 100 μm or less | | | | |
| (%) | | | | |
| Content of particles | 99 | 98 | 100 | 100 |
| with 0.01 to 10 μm | | | | |
| (%) | | | | |

TABLE 2

| | Comparative | Comparative | Comparative |
|---|---|---|---|
| | Example 1 | Example 2 | Example 3 |
| Added solvent | nothing | water | Nothing |
| at stripping | | | |
| Solvent contained | xylene | xylene | Xylene |
| in base polymer | | | |
| polyol | | | |
| Viscosity | 5000 | 5000 | 5000 |
| (mPa · s/25° C.) | | | |
| Polymer | 50 | 50 | 50 |
| concentration | | | |
| (%) | | | |
| acrylonitrile | 150 | 1 | 1 |
| (ppm) | | | |
| styrene | 900 | 10 | 15 |
| (ppm) | | | |
| Total of | 1050 | 11 | 16 |
| acrylonitrile and | | | |
| styrene | | | |
| Stripping time | 2 | 2 | 10 |
| (hr) | | | |
| Filtration | 300 | 140 | 250 |
| property | | | |
| (g/5 min) | | | |
| Average particle | 2.2 | 10.5 | 2.3 |
| size | | | |
| (μm) | | | |
| Content of | 99 | 90 | 97 |
| particles with | | | |
| 100 μm or less | | | |
| (%) | | | |
| Content of | 97 | 81 | 90 |
| particles with | | | |
| 0.01 to 10 μm | | | |
| (%) | | | |

### INDUSTRIAL APPLICABILITY

The present invention can provide polymer polyol having a smaller amount of residual monomers (acrylonitrile, styrene, and the like) and having an excellent filtration property. The process of the present invention does not require specific equipment and so the low cost production is possible. Furthermore, since the stripping time can be shortened, high productivity is possible. Therefore, the polymer polyol of the present invention is useful for a raw material in producing polyurethane, etc. A polymer polyol effective in improving the physical property of polyurethane molded product or in facilitating the molding system can be provided.

1. A process for producing polymer polyol in which a residual monomer is reduced, the process comprising: removing an organic solvent (II) from a liquid composition including a base polymer polyol (I) obtained by polymerizing ethylenically unsaturated monomer (b) in polyol (A) and an organic solvent (II) that is present in a content of not less than 3 mass % with respect to (I), wherein the organic solvent (II) comprises an organic solvent (II-1) having a SP value of 7 to 14 (cal/cm³)^{1/2} and a boiling point that satisfies the following relational formula (1):
850/s≦bp≦1100/s (1)
where
s represents an SP value of the organic solvent, and
bp represents a boiling point of the organic solvent.

2. A process for producing polymer polyol in which a residual monomer is reduced, the process comprising: mixing a base polymer polyol (I) obtained by polymerizing ethylenically unsaturated monomer (b) in polyol (A) and an organic solvent (II) that is present in a content of not less than 3 mass % with respect to (I); and removing the organic solvent (II) from a liquid composition, wherein the organic solvent (II) comprises an organic solvent (IIa) having a SP value of 7 to 14 (cal/cm³)^{1/2} and a boiling point of 60° C. to 150° C.

3. The process for producing polymer polyol according to claim 1, wherein the organic solvent (II) comprises an organic solvent (II-1) having a SP value of 7 to 14 (cal/cm³)^{1/2} and a boiling point that satisfies the following relational formula (1) and an organic solvent (II-2) having a SP value of 9 to 11 (cal/cm³)^{1/2} and a boiling point that satisfies the following relational formula (2); and wherein the content of (II-1) in (II) is 70 to 99.9 mass % and the content of (II-2) in (II) is 0.1 to 30 mass %:
850/s≦bp≦100/s (1)
1100/s≦bp≦150 (2)
where
s represents an SP value of the organic solvent, and
bp represents a boiling point of the organic solvent.

4. The process for producing polymer polyol according to claim 1, wherein (II) is at least one selected from the group consisting of methanol, ethanol, isopropanol, butanol, xylene, toluene, hexane, heptane, cyclohexane and methyl ethyl ketone.

5. The process for producing polymer polyol according to claim 1, wherein the polymer polyol contains 25 to 75 mass % of polymer (B) which is a polymer of (b).

6. The process for producing polymer polyol according to claim 1, wherein (b) comprises acrylonitrile and/or styrene in an amount of 50 mass % or more.

7. The process for producing polymer polyol according to claim 6, wherein the content of acrylonitrile in polymer polyol is reduced to 100 ppm or less and the content of styrene in polymer polyol is reduced to 150 ppm or less.

8. Polymer polyol comprising 25 to 60 mass % polyol (A) and 40 to 75 mass % of polymer particles (B 1) formed by polymerizing ethylenically unsaturated monomer in the polyol (A), the ethylenically unsaturated monomer having a content of acrylonitrile and/or styrene of not less than 50 mass %, wherein (B1) has a particle size of not more than 100 μm and contains not less than 95 mass % of particles with a particle size of 0.01 to 10 μm; and the total content of acrylonitrile and styrene is not more than 20 ppm.

9. The process for producing polymer polyol according to claim 2, wherein the organic solvent (II) comprises an organic solvent (II-1) having a SP value of 7 to 14 (cal/cm³)^{1/2} and a boiling point that satisfies the following relational formula (1) and an organic solvent (II-2) having a SP value of 9 to 11 (cal/cm³)^{1/2} and a boiling point that satisfies the following relational formula (2); and wherein the content of (II-1) in (II) is 70 to 99.9 mass % and the content of (II-2) in (II) is 0.1 to 30 mass %:
850/s≦bp≦1100/s (1)
1100/s≦bp≦150 (2)
where
s represents an SP value of the organic solvent, and
bp represents a boiling point of the organic solvent.

10. The process for producing polymer polyol according to claim 2, wherein (II) is at least one selected from the group consisting of methanol, ethanol, isopropanol, butanol, xylene, toluene, hexane, heptane, cyclohexane and methyl ethyl ketone.

11. The process for producing polymer polyol according to claim 2, wherein the polymer polyol contains 25 to 75 mass % of polymer (B) which is a polymer of (b).

12. The process for producing polymer polyol according to claim 2, wherein (b) comprises acrylonitrile and/or styrene in an amount of 50 mass % or more.

13. The process for producing polymer polyol according to claim 12, wherein the content of acrylonitrile in polymer polyol is reduced to 100 ppm or less and the content of styrene in polymer polyol is reduced to 150 ppm or less.
